(19) United States
(12) Patent Application Publication
(10) Pub. No.: US 2026/0186606 A1
(43) Pub. Date: Jul. 2, 2026

(54) ELECTRONIC COMPONENT, DISPLAY MODULE, AND ELECTRONIC DEVICE HAVING THE SAME

(71) Applicant: Samsung Display Co., LTD., Yongin-si (KR)

(72) Inventors: JUNGHA SON, Yongin-si (KR); JUNGHAK KIM, Yongin-si (KR); YUN A MA, Yongin-si (KR); SANGWOOK YOO, Yongin-si (KR); JEONGHEON LEE, Yongin-si (KR)

(21) Appl. No.: 19/242,215

(22) Filed: Jun. 18, 2025

(30) Foreign Application Priority Data
Dec. 30, 2024 (KR) 10-2024-0200514

(51) Int. Cl. G06F 3/044; G06F 3/041

(52) U.S. Cl. CPC G06F 3/044; G06F 3/04164

(57) ABSTRACT

A display module includes a display panel, a plurality of sensors, a plurality of multiplexors, a plurality of spider lines, a plurality of flexible printed circuit boards, a circuit board, and a plurality of input detection driving circuits. The plurality of sensors and the plurality of plurality of input detection driving circuits detects a user's touch by using a self-dot method. The circuit board electrically connects the plurality of sensors and the plurality of input detection driving circuits to each other. The circuit board includes a plurality of connection lines, and a portion and another portion of at least one of the plurality of connection lines are disposed in different layers of the circuit board.

This application claims priority to Korean Patent Application No. 10-2024-0200514, filed on Dec. 30, 2024, and all the benefits accruing therefrom under 35 U.S.C. § 119, the content of which in its entirety is herein incorporated by reference.

### BACKGROUND

### 1. Field

The present disclosure relates to an electronic part, a display module, and an electronic device including thereof, and more specifically, to an electronic part and a display module for providing an input detection circuit having a large area, and an electronic device including thereof.

### 2. Description of the Related Art

Various display devices used in a multi-media device, such as a television, a cellphone, a tablet computer, a navigation, or a game console, are being developed. In such display device, a keyboard or a mouse may be provided, for example, as an input device thereof.

In addition, such display devices may include an input detection circuit configured to detect a touch of a user or a pressure applied by a user, as an input device thereof.

A display device may be configured to detect a finger of a person making contact on a screen thereof through an input detection circuit. An input detection circuit may use various methods of detecting a touch, such as a resistive film method, an optical method, a capacitive method, or an ultrasonic method. Among these methods, the capacitive method uses a capacitance changing upon a contact of a touch generating means on a screen of a display device to detect whether a touch occurs.

In various recent electronic devices including a vehicle, a display device having a large size is being used. In case that such a display device having a large size detects an input by a touch, a performance of detecting a touch may be reduced.

### SUMMARY

An embodiment of the present disclosure is to provide a display module and an electronic device including an input detection circuit having improved touch sensibility.

In addition, another embodiment of the present disclosure is to provide an electronic part configured to improve a touch sensibility of an input detection circuit.

A display module according to an embodiment of the present disclosure includes a display panel, a plurality of sensors, a first multiplexor, a second multiplexor, a first spider line, a second spider line, a plurality of flexible printed circuit boards, a circuit board, a first input detection driving circuit, and a second input detection driving circuit. In such an embodiment, the display panel includes a display region and a non-display region surrounding the display region. In such an embodiment, the plurality of sensors may be provided on the display region and disposed adjacent to a first sensor. In such an embodiment, the first multiplexor is electrically connected to the first sensor, and the second multiplexor is electrically connected to a second sensor and spaced apart from the first multiplexor. In such an embodiment, the first spider line is electrically connected to the first multiplexor and provided on the non-display region and have a first length. In such an embodiment, the second spider line is electrically connected to the second multiplexor and provided on the non-display region and have a second length shorter than the first length. At least any one of the plurality of flexible printed circuit boards may be electrically connected to at least any one of the first spider line and the second spider line. In such an embodiment, the circuit board includes a first connection line having a third length and a second connection line having a fourth length longer than the third length, and the first connection line and the second connection line may be electrically connected to the first spider line and the second spider line, respectively, through at least any one of the plurality of flexible printed circuit boards.

In such an embodiment, the first input detection driving circuit is electrically connected to the first connection line and mounted on the circuit board. In such an embodiment, the second input detection driving circuit is electrically connected to the second connection line and mounted on the circuit board.

In an embodiment of the present disclosure, the circuit board may further include a first substrate layer, a second substrate layer, and a first substrate insulating layer disposed between the first substrate layer and the second substrate layer. In such an embodiment, the first connection line may be provided on the first substrate layer. In such an embodiment, a portion of the second connection line may be disposed on the first substrate layer, and another portion of the second connection line may be disposed between the first substrate insulating layer and the second substrate layer.

In an embodiment of the present disclosure, the circuit board may further include a first substrate layer, a second substrate layer, and a first substrate insulating layer disposed between the first substrate layer and the second substrate layer. In such an embodiment, the first connection line may include a first upper connection line disposed on the first substrate layer, and a first lower connection line disposed between the first substrate insulating layer and the second substrate layer. In such an embodiment, the second connection line may include a second upper connection line disposed on the first substrate layer, and a second lower connection line disposed between the first substrate insulating layer and the second substrate layer.

In an embodiment of the present disclosure, the circuit board may further include a first substrate layer, a second substrate layer, a third substrate layer, a first substrate insulating layer disposed between the first substrate layer and the second substrate layer, and a second substrate insulating layer disposed between the second substrate layer and the third substrate layer. In such an embodiment, the first connection line may include a first upper connection line disposed on the first substrate layer, and a first lower connection line disposed between the first substrate insulating layer and the second substrate layer. In such an embodiment, the second connection line may include a second upper connection line disposed on the first substrate layer, a middle connection line disposed between the first substrate insulating layer and the second substrate layer, and a second lower connection line disposed between the second substrate insulating layer and the third substrate layer.

In an embodiment of the present disclosure, a capacitance formed by the first connection line with other elements may be 0.9 times or greater and 1.1 times or less of a capacitance formed by the second connection line with other elements.

In an embodiment of the present disclosure, no sensor among the plurality of sensors may be disposed between the first sensor and the second sensor. In such an embodiment, the second sensor may be spaced apart from the first sensor in a first direction, and the second multiplexor may be spaced apart from the first multiplexor in the first direction.

In an embodiment of the present disclosure, the first input detection driving circuit may detect a change in a capacitance formed by the first sensor with other elements. In such an embodiment, the second input detection driving circuit may detect a change in a capacitance formed by the second sensor with other elements.

In an embodiment of the present disclosure, the plurality of flexible printed circuit boards may be bendable to have the circuit board overlap the display panel.

An electronic device according to an embodiment of the present disclosure includes a plurality of sensors, a first multiplexor, a second multiplexor, a first spider line, a second spider line, a circuit board, a first input detection driving circuit, and a second input detection driving circuit. In such an embodiment, the plurality of sensors includes a first sensor and a second sensor disposed adjacent to the first sensor, and each of the first sensor and the second sensor forms a capacitance with objects approaching from outside. In such an embodiment, the first multiplexor is electrically connected to the first sensor, and the second multiplexor is electrically connected to the second sensor and spaced apart from the first multiplexor. In such an embodiment, the first spider line is electrically connected to the first multiplexor and has a first length. In such an embodiment, the second spider line is electrically connected to the second multiplexor and has a second length shorter than the first length. In such an embodiment, the circuit board includes a first connection line having a third length and a second connection line having a fourth length longer than the third length. In such an embodiment, the first connection line is electrically connected to the first spider line, and the second connection line is electrically connected to the second spider line. In such an embodiment, the first input detection driving circuit is electrically connected to the first connection line and the first input detection driving circuit detects a change in the capacitance of the first sensor. In such an embodiment, the second input detection driving circuit is electrically connected to the second connection line and the second input detection driving circuit detects the change in a capacitance of the second sensor.

In an embodiment of the present disclosure, the circuit board may further include a first substrate layer, a first substrate insulating layer disposed below the first substrate layer, and a second substrate layer disposed below the first substrate insulating layer. In such an embodiment, a portion of the second connection line may be disposed on the first substrate layer, and another portion of the second connection line may be disposed between the first substrate insulating layer and the second substrate layer.

In an embodiment of the present disclosure, no sensor among the plurality of sensors may be disposed between the first sensor and the second sensor.

In an embodiment of the present disclosure, the first sensor may be electrically insulated from the second sensor.

In an embodiment of the present disclosure, the plurality of sensors may each allow penetration or passing of at least some of incident light.

An electronic device according to an embodiment of the present disclosure may further include a display panel disposed to overlap the plurality of sensors.

An electronic device according to an embodiment of the present disclosure may further include a plurality of flexible printed circuit boards. At least any one of the plurality of flexible printed circuit boards may be electrically connected to at least any one of the first spider line and the second spider line.

In an embodiment of the present disclosure, a capacitance formed by the first connection line with other elements may be 0.9 times or greater and 1.1 times or less of a capacitance formed by the second connection line with other elements.

An electronic part according to an embodiment of the present disclosure includes a first substrate layer, a first substrate insulating layer disposed below the first substrate layer, a second substrate layer disposed below the first substrate insulating layer, and a plurality of connection lines, each of which has at least a portion disposed on the first substrate layer. In such an embodiment, among the plurality of connection lines, a length of a first connection line electrically connected to a first external part is different from a length of a second connection line electrically connected to a second external part.

In an embodiment of the present disclosure, a portion of the second connection line may be disposed on the first substrate layer, and another portion of the second connection line may be disposed between the first substrate insulating layer and the second substrate layer.

In an embodiment of the present disclosure, the first external part may be a first multiplexor, and the second external part may be a second multiplexor spaced part from the first multiplexor.

An electronic part according to an embodiment of the present disclosure may further include a first input detection driving circuit electrically connected to the first multiplexor, and a second input detection driving circuit electrically connected to the second multiplexor.

According to an embodiment of the present disclosure, it becomes possible to provide a display module and an electronic device including an input detection circuit with improved touch sensibility.

According to an embodiment of the present disclosure, it becomes possible to provide an electronic part configured to enhance a touch sensibility of an input detection circuit.

### BRIEF DESCRIPTION OF THE DRAWINGS

These and/or other features of embodiments of the disclosure will become apparent and more readily appreciated from the following description of the embodiments, taken in conjunction with the accompanying drawings, in which:

FIG. 1 is a schematic illustration of an electronic device according to an embodiment of the present disclosure;

each of FIGS. 2A, 2B, 2C and 2D is a schematic cross-sectional view of the electronic device shown in FIG. 1;

FIG. 3 is a schematic illustration of a display module according to an embodiment of the present disclosure;

FIG. 4 is an equivalent circuit diagram of a pixel according to an embodiment of the present disclosure;

FIG. 5 is a signal timing diagram of electronic signal for operation of the pixel shown in FIG. 4;

FIG. 6 is a schematic illustration of a cross-section of a display panel according to an embodiment of the present disclosure;

FIG. 7 is a schematic illustration showing an operation method of an input detection circuit according to an embodiment of the present disclosure;

each of FIGS. 8A and 8B is a schematic illustration of a portion of a cross-section of a circuit board according to an embodiment of the present disclosure;

each of FIGS. 9A and 9B is a schematic illustration of a portion of a cross-section of a circuit board according to an embodiment of the present disclosure;

each of FIGS. 10A and 10B is a schematic illustration of a portion of a cross-section of a circuit board according to an embodiment of the present disclosure;

FIG. 11 is a schematic illustration of a planarly viewed shape of a portion of a circuit board according to an embodiment of the present disclosure;

FIG. 12 is a block diagram of an electronic device according to an embodiment; and

FIG. 13 are schematic diagrams of an electronic device according to various embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A display device according to an embodiment may be applicable to various electronic devices. An electronic device according to an embodiment may include the described display device and further include a module or a device having an additional function other than the display device.

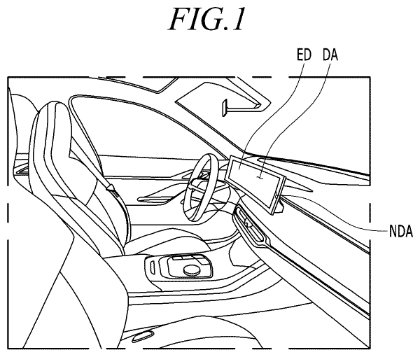

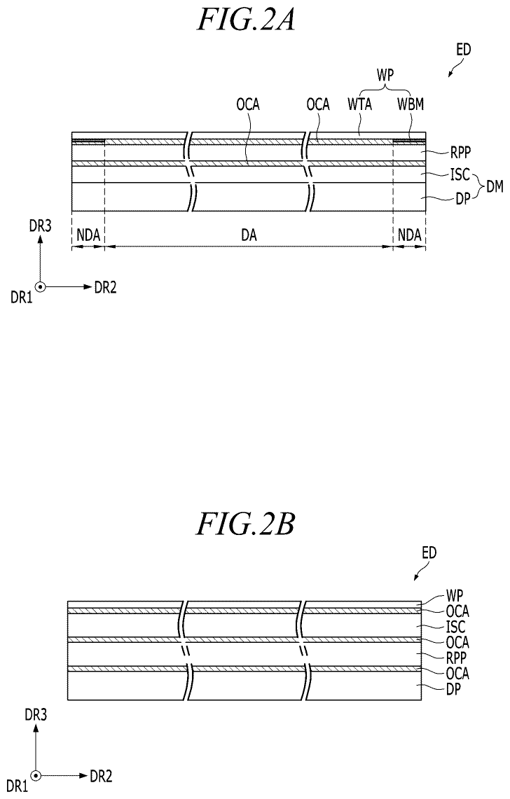

FIG. 1 is a schematic illustration of an electronic device ED according to an embodiment of the present disclosure.

FIG. 1 illustrates an embodiment of an electronic device ED mounted on a vehicle. However, a device in which the electronic device ED is included is not limited thereto.

An electronic device ED may have a display region DA and a non-display region NDA defined therein. The display region DA may be configured to display an image and detect an input of a user.

The shape of the display region DA shown in FIG. 1 is merely an example, and a shape of the display region DA may be modified as desired without limitation.

The non-display region NDA may be a region adjacent to the display region DA and a region where an image is not displayed. A bezel area of the electronic device ED may be defined by the non-display region NDA. The non-display region NDA may surround the display region DA. However, a shape of the non-display region NDA is not limited thereto. A shape of the display region DA and a shape of the non-display region NDA may be variously modified.

FIGS. 2A through 2D are schematic illustrations of cross-sectional views of an electronic device ED according to an embodiment of the present disclosure.

FIGS. 2A through 2D are simplified for convenience of illustration of a functional panel included in an electronic device ED and/or a lamination structure of functional panels.

In an embodiment, at least a portion of the display region DA may be parallel to a plane defined by a first directional axis DR1 and a second directional axis DR2. A normal direction of the display region DA, i.e., a thickness direction of the electronic device ED, may be a third directional axis DR3. A front surface (or an upper surface) and a back surface (or a lower surface) of each member may be distinguished by the third directional axis DR3. However, directions pointed by the first through the third directional axes DR1, DR2 and DR3 are merely a relative concept and may be converted into other directions. Hereinafter, a first through a third directions DR1, DR2 and DR3 are directions pointed by the first through the third directional axes DR1, DR2 and DR3, respectively, and described with the same reference characters.

Referring to FIG. 2A, in an embodiment, an electronic device ED may include a display module DM, a reflection protection (or antireflection) member RPP, a window member WP, and a plurality of adhesive parts OCA.

The display module DM may include a display panel DP and an input (or touch) detection circuit ISC. The display module DM may emit light and detect an input (or a touch thereon). In an embodiment, a base member may be further disposed below the display module DM.

The display panel DP may emit light. The display panel DP according to an embodiment may be a light-emitting display panel. In an embodiment, for example, the display panel DP may be an organic light-emitting display panel, a quantum dot light-emitting display panel, or a micro light-emitting display panel.

The input detection circuit ISC may be provided on the display panel DP. The input detection circuit ISC may obtain a coordination information of an external input. In an embodiment, for example, at least one selected from a capacitance type input sensor, a resistance film type input sensor, an optical sensor, an electromagnetic resonance type input sensor, an ultrasonic type input sensor, and an infrared wave type input sensor may be used as the input detection circuit ISC.

The reflection protection member RPP may be provided on the display module DM. The reflection protection member RPP may reduce a light reflection rate of an external light incident from an upper side of the window member WP. The reflection protection member RPP according to an embodiment of the present disclosure may include a retarder, a polarizer, and a plurality of color filters.

The window member WP may be disposed on the reflection protection member RPP. The window member WP may include a light-transmitting part WTA and a light-blocking part WBM.

The light-transmitting part WTA may include glass and/or synthetic resin. The light-transmitting part WTA may be defined by a single layer, but not being limited thereto. The light-transmitting part WTA may include two or more films coupled to each other by an adhesive member. At least a portion of the light-transmitting part WTA may overlap the display region DA of the electronic device ED.

The light-blocking part WBM may partially overlap the light-transmitting part WTA. The light-blocking part WBM may be disposed below the light-transmitting part WTA to overlap the non-display region NDA of the electronic device ED.

The plurality of adhesive parts OCA may be optically transparent adhesive members. The plurality of adhesive parts OCA may each be disposed between a lower member and an upper member to attach the lower member and the upper member to each other.

A portion of the plurality of adhesive parts OCA may be disposed between the display module DM and the reflection protection member RPP. Another portion of the plurality of adhesive parts OCA may be disposed between the reflection protection member RPP and the window member WP.

Positions of the plurality of adhesive parts OCA are not limited thereto. The plurality of adhesive parts OCA may be further disposed between the display panel DP and the input detection circuit ISC. In addition, at least some of the plurality of adhesive parts OCA may be omitted.

Referring to FIG. 2B, in another embodiment, the electronic device ED may include a display panel DP, a reflection protection member RPP, an input detection circuit ISC, and a window member WP.

In such an embodiment, a portion of the plurality of adhesive parts OCA may be disposed between the display panel DP and the reflection protection member RPP. Another portion of the plurality of adhesive parts OCA may be disposed between the reflection protection member RPP and the input detection circuit ISC. Yet another portion of the plurality of adhesive parts OCA may be disposed between the input detection circuit ISC and the window member WP.

Referring to FIG. 2C, in another embodiment, positions of the reflection protection member RPP and the input detection circuit ISC may be switched in the lamination structure shown in FIG. 2B.

Referring to FIG. 2D, in another embodiment, the plurality of adhesive parts OCA may be omitted, and the display panel DP, the input detection circuit ISC, the reflection protection member RPP, and the window member WP may be successively laminated in the electronic device ED. In another embodiment, the lamination order of the input detection circuit ISC and the reflection protection member RPP may be variously modified.

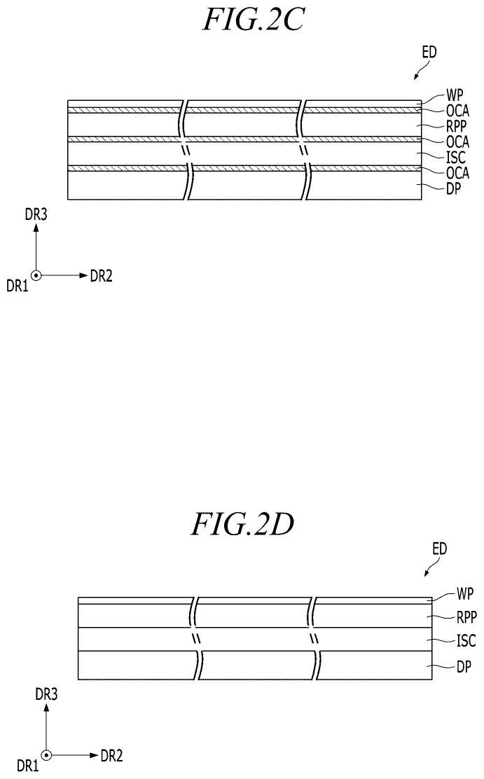

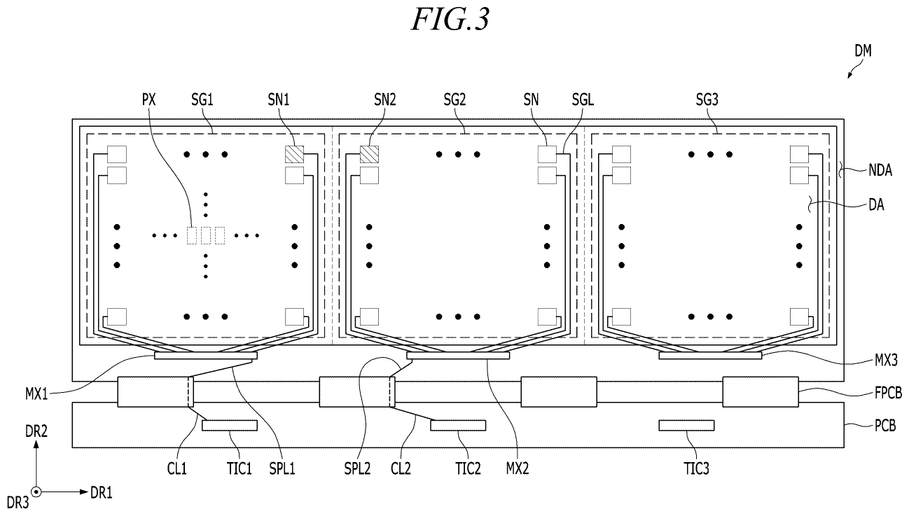

FIG. 3 is a schematic illustration of a plan view of a display module DM according to an embodiment of the present disclosure.

Referring to FIG. 3, in an embodiment, the display panel DP may include a display region DA and a non-display region NDA defined therein. The non-display region NDA may be defined along an outer periphery of the display region DA. The display region DA may correspond to the display region DA of the electronic device ED shown in FIG. 1. The non-display region NDA may correspond to the non-display region NDA of the electronic device ED shown in FIG. 1.

The display module DM may include a plurality of pixels PX, a plurality of sensor groups SG1, SG2, and SG3, a plurality of multiplexors MX1, MX2, and MX3, a plurality of flexible printed circuit boards FPCB, a circuit board PCB, a plurality of input detection driving circuits TIC1, TIC2, and TIC3, and a control driving circuit (not shown).

The plurality of pixels PX may be disposed on the display region DA of the display panel DP. The plurality of pixels PX may each emit light.

The plurality of sensor groups SG1, SG2, and SG3 may be disposed on the display region DA of the display panel DP. The plurality of sensor groups SG1, SG2, and SG3 may each include a plurality of sensors SN. A first sensor group SG1, a second sensor group SG2, and a third sensor group SG3 may be sequentially arranged in the first direction DR1.

A plurality of sensors SN according to an embodiment of the present disclosure may be sensors configured to detect a touch in a self-dot method. Accordingly, the plurality of sensors SN may be arranged in a matrix shape in a plan view or when viewed in the third direction DR3. In addition, the plurality of sensors SN may each be electrically connected to signal lines SGL to be electrically connected to a corresponding multiplexor among the plurality of multiplexors MX1, MX2 and MX3.

The plurality of sensors SN may be electrically insulated from one another. The plurality of sensors SN may each be transparent to allow penetration or passing of at least some of incident light.

The plurality of multiplexors MX1, MX2, and MX3 may be disposed on the non-display region NDA of the display panel DP.

The plurality of multiplexors MX1, MX2, and MX3 may include a first multiplexor MX1, a second multiplexor MX2, and a third multiplexor MX3. The first multiplexor MX1, the second multiplexor MX2, and the third multiplexor MX3 may be sequentially arranged in the first direction DR1.

The first multiplexor MX1 may be electrically connected to a plurality of sensors SN of the first sensor group SG1. The first multiplexor MX1 may transfer an electrical signal received from the sensors SN of the first sensor group SG1 to a first input detection driving circuit TIC1 or an electrical signal received from a first input detection driving circuit TIC1 to the sensors SN of the first sensor group SG1.

The second multiplexor MX2 may be electrically connected to a plurality of sensors SN of the second sensor group SG2. The second multiplexor MX2 may transfer an electrical signal received from the sensors SN of the second sensor group SG2 to a second input detection driving circuit TIC2 or an electrical signal received from a second input detection driving circuit TIC2 to the sensors SN of the second sensor group SG2.

The third multiplexor MX3 may be electrically connected to a plurality of sensors SN of the third sensor group SG3. The third multiplexor MX3 may transfer an electrical signal received from the sensors SN of the third sensor group SG3 to a third input detection driving circuit TIC3 or an electrical signal received from a third input detection driving circuit TIC3 to the sensors SN of the third sensor group SG3.

The plurality of flexible printed circuit boards FPCB may include the display panel DP and the circuit board PCB electrically connected. The plurality of flexible printed circuit boards FPCB may be bendable. Accordingly, the circuit board PCB may become disposed below the display DP, and the circuit board PCB and the display panel DP may be disposed to overlap each other in the third direction DR3.

The circuit board PCB may have the plurality of input detection driving circuits TIC1, TIC2, and TIC3 mounted therein. In an embodiment, although not illustrated in FIG. 3, the circuit board PCB may further include a control driving circuit (not shown), other than the plurality of input detection driving circuits TIC1, TIC2, and TIC3, further mounted therein. The control driving circuit (not shown) may be an element configured to control various electronic parts, including the plurality of input detection driving circuits TIC1, TIC2, and TIC3.

The circuit board PCB may include a plurality of connection lines CL1 and CL2. The plurality of connection lines CL1 and CL2 may be electrically connected to a printed circuit board FPCB corresponding to the plurality of input detection driving circuits TIC1, TIC2, and TIC3 mounted in the circuit board PCB. For convenience of illustration, FIG. 3 illustrates only a first connection line CL1 and a second connection line CL2 among the plurality of connection lines.

The plurality of input detection driving circuits TIC1, TIC2, and TIC3 may be mounted in the circuit board PCB. Through the plurality of sensor groups, the plurality of input detection driving circuits TIC1, TIC2, and TIC3 may be configured to process a signal corresponding to a change in a current by a user's touch applied to the display region DA or a signal corresponding to a pressure applied from outside. In this specification, the circuit board PCB and the plurality of input detection driving circuits TIC1, TIC2, and TIC3 may be referred as electronic parts.

In a case configured to detect a touch in a self-dot method, every sensor SN is typically connected to a signal line SGL. Accordingly, in order to include the plurality of sensors SN disposed on the display panel DP having a large area and to detect a touch in a self-dot method, the number of the signal lines SGL are increased. This leads to a problem of increased resistance and capacitance and lack of space due to the increase in the number of pads connected thereto. In order to resolve these problems, a plurality of multiplexors MX1, MX2, and MX3 may be used.

As the plurality of multiplexors MX1, MX2, and MX3 are used to connect the sensors SN to different input detection driving circuits TIC1, TIC2, and TIC3 among the plurality of input detection driving circuits TIC1, TIC2, and TIC3, there can be problems in the sensors'SN detecting a touch due to a difference in a resistance or a capacitance caused by different lengths of lines. A method of overcoming these problems will hereinafter be described with a first sensor SN1 and a second sensor SN2.

Referring to FIG. 3, a first sensor SN1 of a first sensor group SG1 and a second sensor SN2 of a second sensor group SG2 are disposed adjacent to each other, and there is no other sensors disposed between the first sensor SN1 and the second sensor SN2.

The first sensor SN1 may be electrically connected to a first multiplexor MX1 via a corresponding signal line SGL. The first multiplexor MX1 may be configured to electrically connect the first sensor SN1 to a corresponding printed circuit board FPCB via a first spider line SPL1. The printed circuit board FPCB may be configured to electrically connect the first spider line SPL1 and a first connection line CL1. As the first connection line CL1 is electrically connected to the first input detection driving circuit TIC1, the first sensor SN1 and a first input detection driving circuit TIC1 may be electrically connected to each other.

The second sensor SN2 may be electrically connected to a second multiplexor MX2 via a corresponding signal line SGL. The second multiplexor MX2 may be configured to electrically connect the second sensor SN2 to a corresponding printed circuit board FPCB via a second spider line SPL2. The printed circuit board FPCB may be configured to electrically connect the second spider line SPL2 and a second connection line CL2. As the second connection line CL2 is electrically connected to the second input detection driving circuit TIC2, the second sensor SN2 and a second input detection driving circuit TIC2 may be electrically connected to each other.

Here, because a first length of the first spider line SPL1 is shorter than a second length of the second spider line SPL2, the first spider line SPL1 and the second spider line SPL2 may each have a different resistance or capacitance formed with other elements. Due to the above, there may be a problem in the first sensor's SN1 and the second sensor's SN2 detection of a touch. Accordingly, by having a third length of the first connection line CL1 shorter than a fourth length of the second connection line CL2, it may be possible to effectively prevent a problem in the first sensor's SN1 and the second sensor's SN2 detection of a touch due to a difference in a resistance or capacitance. Therefore, a first capacitance, which the first connection line CL1 forms with other elements may be 0.9 times or greater and 1.1 times or less of a second capacitance, which the second connection line CL2 forms with other elements. In a case that the first capacitance is less than 0.9 times or greater than 1.1 times of the second capacitance, there may be a problem in the first sensor's SN1 and the second sensor's SN2 detection of a touch due to the difference in the capacitances.

A method of controlling a length of the first connection line CL1 and a length of the second connection line CL2 will be described in detail with reference to FIGS. 8A through 10B.

In another embodiment, although the first sensor SN1 and the second sensor SN2 are disposed adjacent to each other, the first sensor SN1 and the second sensor SN2 are controlled by different input detection driving circuits TIC1 and TIC2. Therefore, a length control as in the present disclosure would be desired, but in a case that two adjacent sensors SN are controlled by a same input detection driving circuit, there may be no problem even without a separate control of a length of a line.

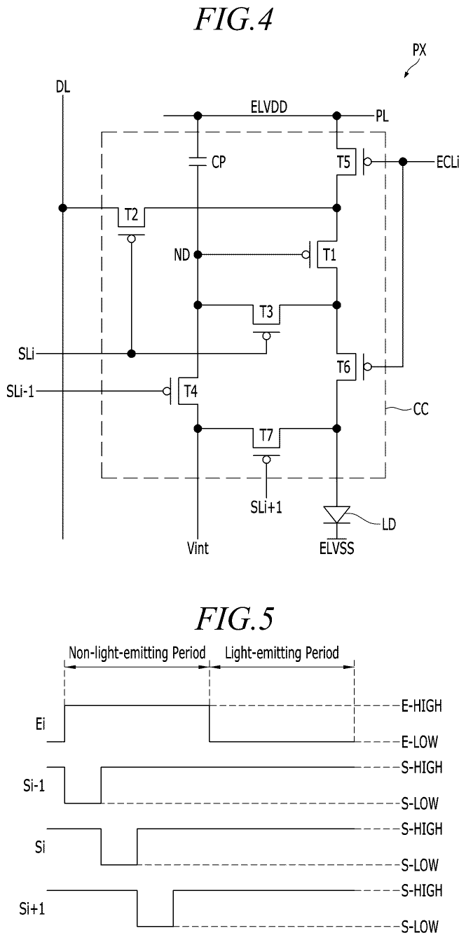

FIG. 4 is an equivalent circuit of a pixel PX according to an embodiment of the present disclosure. FIG. 5 is a signal timing diagram of a light-emission control signal Ei, and scan signals Si−1, Si, and Si+1 applied to the pixel PX in FIG. 4. FIG. 4 illustrates an embodiment of a pixel PX connected to an i-th scan line SLi and an i-th light-emission control line ECLi.

In an embodiment, a pixel PX may include a light-emitting diode LD and a pixel circuit CC. The pixel circuit CC may include a plurality of transistors T1 through T7 and a capacitor CP. The pixel circuit CC may be configured to control an amount of current flowing through the light-emitting diode LD in response to a data signal.

The light-emitting diode LD may be configured to emit light with a luminance corresponding to an amount of current provided from the pixel circuit CC. In an embodiment, a level of a first power voltage ELVDD may be set higher than a level of a second power voltage ELVSS.

The plurality of transistors T1 through T7 may each include an input electrode (or a source electrode), an output electrode (or a drain electrode) and a control electrode (or a gate electrode). In this specification, one of the input electrode and the output electrode may be referred as a first connection electrode, and the other thereof may be referred as a second connection electrode for convenience of description.

A first connection electrode of a first transistor T1 may be connected to a first power voltage ELVDD via a fifth transistor T5, and a second connection electrode may be connected to a first driving electrode of the light-emitting diode LD via a sixth transistor T6. The first transistor T1 may be referred as a driving transistor in this specification.

The first transistor T1 may control an amount of current flowing through the light-emitting diode LD in response to a voltage applied to a control electrode thereof.

A second transistor T2 may be connected between a data line DL and the first connection electrode of the first transistor T1. In addition, a control electrode of the second transistor T2 may be connected to an i-th scan line SLi. When an i-th scan signal Si is provided to an i-th scan line SLi, the second transistor T2 may be turned on to electrically connect the data line DL and the first connection electrode of the first transistor T1 to each other.

A third transistor T3 may be connected between the second connection electrode of the first transistor T1 and the control electrode. A control electrode of the third transistor T3 may be connected to the i-th scan line SLi. When the i-th scan signal Si is provided to the i-th scan line SLi, the third transistor T3 may be turned on to electrically connect the second connection electrode and the control electrode of the first transistor T1 to each other. Therefore, when the third transistor T3 is turned on, the first transistor T1 may be connected in a form of a diode.

A fourth transistor T4 may be connected between a node ND and an initialization power generation unit (not shown). In addition, a control electrode of the fourth transistor T4 is connected to an (i−1)-th scan line SLi-1. When the (i−1)-th scan signal Si−1 is provided to an (i−1)-th scan line SLi-1, the fourth transistor T4 may be turned on to provide an initialization voltage Vint to the node ND.

A fifth transistor T5 may be connected between a power line PL and the first connection electrode of the first transistor T1. Here, the power line PL may transmit the first power voltage ELVDD. A control electrode of the fifth transistor T5 may be connected to an i-th light-emission control line ECLi.

A sixth transistor T6 may be connected between the second connection electrode of the first transistor T1 and the first driving electrode of the light-emitting diode LD. In addition, a control electrode of the sixth transistor T6 may be connected to the i-th light-emission control line ECLi.

A seventh transistor T7 may be connected between the initialization power generation unit (not shown) and the first driving electrode of the light-emitting diode LD. In addition, a control electrode of the seventh transistor T7 may be connected to an (i+1)-th scan line SLi+1. When an (i+1)-th scan signal Si+1 is provided to an (i+1)-th scan line SLi+1, such seventh transistor T7 may be turned on to provide the initialization voltage Vint to the first driving electrode of the light-emitting diode LD.

The seventh transistor T7 may improve black expression capability of a pixel PX. In an embodiment, for example, when the seventh transistor T7 is turned on, a parasitic capacitor (not shown) of the light-emitting diode LD may be discharged. Then, when the black luminance is implemented, the light-emitting diode LD does not emit light due to leakage current from the first transistor T1. In this way, the black expression capability of the pixel may be improved.

FIG. 5 illustrates an embodiment where the control electrode of the seventh transistor T7 is connected to an (i+1)-th scan line SLi+1, but the present disclosure is not limited thereto. In another embodiment of the present disclosure, the control electrode of the seventh transistor T7 may be connected to the i-th scan line SLi or the (i−1)-th scan line SLi−1.

FIG. 4 illustrates an embodiment where each transistor of the pixel circuit CC is a p-type metal-oxide-semiconductor (PMOS) transistor, but the present disclosure is not limited thereto. In another embodiment of the present disclosure, each transistor of the pixel circuit CC is an n-type metal-oxide-semiconductor (NMOS) transistors. In yet another embodiment of the present disclosure, the pixel PX may include a combination of an NMOS transistor and a PMOS transistor.

The capacitor CP may be interposed between the power line PL and the node ND. The capacitor CP may be configured to store a voltage corresponding to the data signal. When the fifth transistor T5 and the sixth transistor T6 are turned on, an amount of current flowing through the first transistor T1 may be determined based on a voltage stored in the capacitor CP.

In the present disclosure, a structure of the pixel PX is not limited to the structure shown in FIG. 4. In another embodiment of the present disclosure, the pixel PX may be provided in various forms for the light-emitting diode LD to emit light.

Referring to FIG. 5, the light-emission signal Ei may have a high level E-HIGH or a low level E-LOW. The scan signals Si−1, Si, and Si+1 may each have a high level S-HIGH or a low level S-LOW.

In an embodiment, for example, when the light-emission control signal Ei has a high level E-HIGH, the fifth transistor T5 and the sixth transistor T6 are turned off. When the fifth transistor T5 is turned off, the power line PL and the first connection electrode of the first transistor T1 may be electrically cut off. When the sixth transistor T6 is turned off, the second connection electrode of the first transistor T1 and the first driving electrode of the light-emitting diode LD may electrically cut off. Accordingly, the light-emitting diode LD may not emit light while the light-emission control signal Ei having a high level E-HIGH is provided to the i-th light-emission control line ECLi.

Thereafter, when the (i−1)-th scan signal Si−1provided to the (i−1)-th scan line Sli−1 has a low level S-LOW, the fourth transistor T4 may be turned on. When the fourth transistor T4 is turned on, the initialization voltage Vint may be provided to the node ND.

When the i-th scan signal Si provided to the i-th scan line SLi has a low level S-LOW, the second transistor T2 and the third transistor T3 may be turned on. When the second transistor T2 is turned on, a data signal may be provided to the first connection electrode of the first transistor T1. Here, since the node ND is initialized to the initialization voltage Vint, the first transistor T1 may be turned on. When the first transistor T1 is turned on, a voltage corresponding to the data signal may be provided to the node ND. Here, the capacitor CP may store a voltage corresponding to the data signal.

When the (i+1)-th scan signal Si+1 provide to the (i+1)-th scan line SLi+1 has a low level S-LOW, the seventh transistor T6 may be turned on.

When the seventh transistor T7 is turned on, the initialization voltage Vint may be provided to the first driving electrode of the light-emitting diode LD, thereby discharging the parasitic capacitor of the light-emitting diode LD.

When the light-emission signal Ei provide to the light-emission control line ECLi has a low level E-LOW, the fifth transistor T5 and the sixth transistor T6 may be turned on. The fifth transistor T5 is turned on, the first power voltage ELVDD may be provided to the first connection electrode of the first transistor T1. When the sixth transistor T6 is turned on, the second connection electrode of the first transistor T1 and the first driving electrode of the light-emitting diode LD may be electrically connected to each other. Then, the light-emitting diode LD generates light of a luminance corresponding to an amount of supplied current.

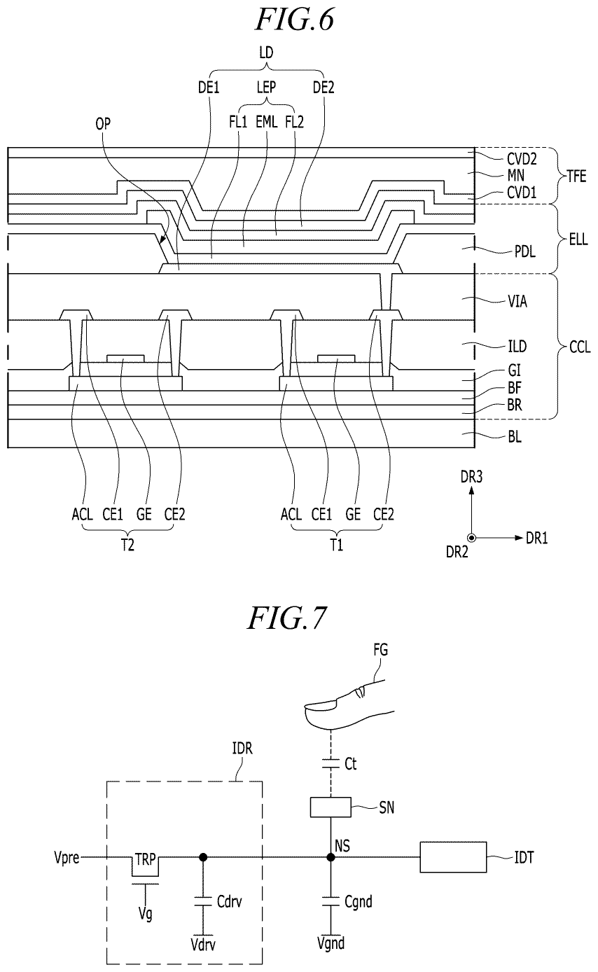

FIG. 6 is a schematic illustration of a cross-section of a display panel DP according to an embodiment of the present disclosure.

In an embodiment, the display panel DP may include a base member BL, a circuit layer CCL, a light-emitting diode layer ELL and an encapsulation layer TFE. Light may be emitted from the display panel DP.

The base member BL may be a base of the display panel DP. That is, other elements of the display panel DP may be laminated on the base member BL. The base member BL may include an organic layer and/or an inorganic layer. The organic layer may include an organic material. In an embodiment, for example, the organic layer may include polyimide. The inorganic layer may include an inorganic material.

The circuit layer CLL may include a barrier layer BR, a buffer layer BF, gate insulating layers GI, an interlayer insulating layer ILD, a circuit insulating layer VIA, a first transistor T1 and a second transistor T2.

The first transistor T1 and the second transistor T2 may be configured to transfer electrical signals. In addition, the first transistor T1 and the second transistor T2 may include a plurality of active parts ACL, a plurality of first connection electrodes CE1, a plurality of control electrodes GE, and a plurality of second connection electrodes CE2.

The barrier layer BR may be proved on the base member BL. The barrier layer BR may be configured to prevent penetration of, for example, moisture introduced from outside. The barrier layer BR may include an inorganic insulating material, such as silicon oxide and silicon nitride.

The buffer layer BF may be provided on the barrier layer BR. The buffer layer BF may intervene transfer of impurities introduced from below towards above. Therefore, an element disposed on the buffer layer BF may be protected. The buffer layer BF may include an inorganic insulating material, such as silicon oxide and silicon nitride.

The plurality of active parts ACL may be provided on the buffer layer BF. The plurality of active parts ACL may include polysilicon or amorphous silicon. Other active parts ACL may include a metal oxide semiconductor. The plurality of active parts ACL may each include a channel area serving as a passage through which electrons or holes may move, and a first ion-doped area and a second ion-doped area disposed with the channel area therebetween.

The gate insulating layer GI covers the buffer layer BF and the plurality of active parts ACL. The gate insulating layer GI may include an organic film and/or an inorganic film. The gate insulating layer GI may include or be defined by a plurality of inorganic thin films. The plurality of inorganic thin films may include a silicon nitride layer and a silicon oxide layer.

A plurality of control electrodes GE may be provided on the buffer layer BF. The plurality of control electrodes GE may overlap the plurality of active parts ACL in the third direction DR3. In addition, the plurality of control electrodes GE may include molybdenum (Mo).

The interlayer insulating layer ILD may be provided on the gate insulating layer GI and cover the plurality of control electrodes GE. The interlayer insulating layer ILD may include an organic film and/or an inorganic film. The interlayer insulating layer ILD may include a plurality of inorganic thin films or organic thin films. The plurality of inorganic thin films may include a silicon nitride layer and a silicon oxide layer.

The plurality of first connection electrodes CE1 and the plurality of second connection electrodes CE may be provided on the interlayer insulating layer ILD. The plurality of first connection electrodes CE1 and the plurality of second connection electrodes CE2 may be electrically connected to the plurality of active parts through contact holes defined in the interlayer insulating layer ILD. In addition, the plurality of first connection electrodes CE1 and the plurality of second connection electrodes CE2 may include metal.

The circuit insulating layer VIA may cover the interlayer insulating layer ILD, the plurality of first connection electrodes CE1 and the plurality of second connection electrodes CE2. The circuit insulating layer VIA may include an organic film and/or an inorganic film. The circuit insulating layer VIA may provide a flat surface or include a flat upper surface. In another embodiment, more circuit insulating layers VIA may be provided as desired.

The light-emitting diode layer ELL may include a pixel defining film PDL and a light-emitting diode LD. Light may be emitted from the light-emitting diode layer ELL.

The pixel defining film PDL may be disposed on a portion of the circuit insulating layer VIA. The pixel defining film PDL may define an opening part OP. In addition, the opening part OP may expose the light-emitting diode LD.

The light-emitting diode LD may be configured to emit light. In addition, the light-emitting diode LD may include a first driving electrode DE1, a light-emitting unit LEP and a second driving electrode DE2.

The first driving electrode DE1 may be provided on a portion of the circuit insulating layer VIA. The opening part OP may expose the first driving electrode DE1. In addition, the first driving electrode DE1 may be electrically connected to a corresponding one of the plurality of second connection electrodes CE2 through contact holes defined in the circuit insulating layer VIA. Therefore, the first driving electrode DE1 may be configured to receive an electrical signal from the first transistor T1 and the second transistor T2.

FIG. 6 illustrates an embodiment of a first transistor T1 and a second transistor T2 of a pixel circuit of a pixel, but the structures of the first transistor T1 and the second transistor T2 are not limited thereto. In FIG. 6, the first transistor T1 is illustrated to make direct contact with the first driving electrode DE1 through one of the plurality of second connection electrodes CE2, but this merely is a cross-sectional shape and is thus shown. In an embodiment, the first transistor T1 may be connected to the first driving electrode DE1 through another transistor. However, the present disclosure is not limited thereto, and in another embodiment of the present disclosure, the first transistor T1 may make direct contact with the first driving electrode DE1 by a corresponding one of the plurality of second connection electrodes CE2.

The first driving electrode DE1 may be an anode electrode of the light-emitting diode LD. A hole may be provided through the first driving electrode DE1. However, a configuration of the first driving electrode DE1 is not limited thereto. In another embodiment of the present disclosure, the first driving electrode DE1 may be a cathode electrode of the light-emitting diode LD and provide an electron, and configurations and effects of a first functional layer FL1 and a second functional layer FL2 may be switched.

The light-emitting unit LEP may include a first functional layer FL1, a light-emitting layer EML and a second functional layer FL2. Light may be emitted from the light-emitting unit LEP.

The first functional layer FL1 may be provided on the first driving electrode DE1. The first functional layer FL1 may be configured to support transfer of a hole generated from the first driving electrode DE1. In an embodiment, for example, the first functional layer FL1 may be configured to more readily receive a hole injected from the first driving electrode DE1 and facilitate transfer of the hole. The first functional layer FL1 may have a multi-layer structure. In an embodiment, for example, the first functional layer FL1 may have a structure of further including, for example, a first injection layer (not shown) and a first transfer layer (not shown).

The light-emission layer EML may be provided on the first functional layer FL1. Light may be emitted from the light-emission layer EML. The light-emission layer EML may include, for example, an organic light-emitting material or a quantum dot. Therefore, the light-emitting diode LD may be an organic light-emitting diode or a quantum dot light-emitting diode.

The second functional layer FL2 may be provided on the light-emission layer EML. The second functional layer FL2 may be configured to support transfer of an electron generated from the second driving electrode DE2. In an embodiment, for example, the second functional layer FL2 may be configured to more readily receive an electron injected from the second driving electrode DE2 and facilitate transfer of the electron. The second functional layer FL2 may have a multi-layer structure. In an embodiment, for example, the second functional layer may have a structure of further including, for example, a second injection layer (not shown) and a second transfer layer (not shown).

The second driving electrode DE2 may be provided on the light-emission part LEP. The second driving electrode DE2 may have a low surface resistance to allow easy flow of a current through the second driving electrode DE2.

The second driving electrode DE2 may be a cathode electrode of the light-emitting diode LD. An electron may be supplied through the second driving electrode DE2. However, a configuration of the second driving electrode DE2 is not limited thereto. In another embodiment of the present disclosure, the second driving electrode DE2 may be an anode electrode of the light-emitting diode LD and supply a hole, and configurations and effects of the first functional layer FL1 and the second functional layer FL2 may be switched.

The second driving electrode DE2 may allow penetration of incident light by a selectable light transmittivity. The light passing through the second driving electrode DE2 may be emitted to outside of the electronic device ED in FIG. 1 and visible to a user.

The second driving electrode DE may reflect incident light by a selectable reflectivity. The light reflected by the second driving electrode DE2 may be reflected by the first driving electrode DE1, and this may cause a resonance phenomenon in the light-emitting diode LD. Due to the occurrence of the resonance phenomenon in the light-emitting diode LD, a light efficiency of the light-emitting diode LD may be increased.

The encapsulation layer TFE may be configured to seal off the light-emitting diode LD to protect the light-emitting diode LD from external oxygen or moisture. The encapsulation layer TFE may include a first inorganic encapsulation layer CVD1, an organic encapsulation layer MN, and a second inorganic encapsulation layer CVD2.

In an embodiment, as shown in FIG. 6, the encapsulation layer TFE may include two inorganic encapsulation layers CVD1 and CVD2, and one organic encapsulation layer MN, but the present disclosure is not limited to this example. In another embodiment, for example, the encapsulation layer TFE may include three inorganic encapsulation layers and two organic encapsulation layers. In such an embodiment, the inorganic encapsulation layers and the organic encapsulation layers may be alternately laminated.

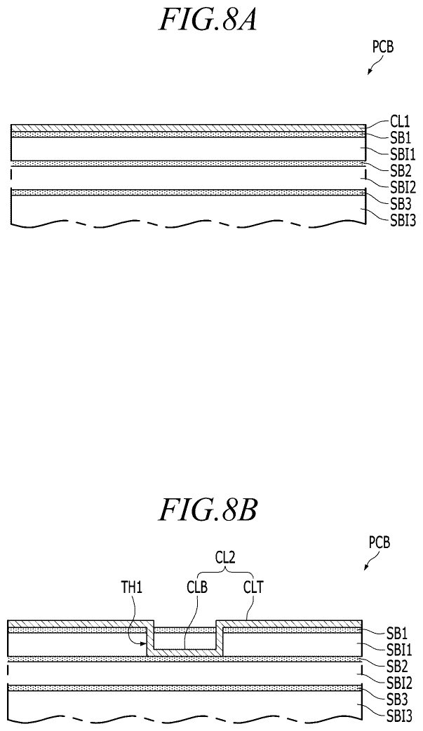

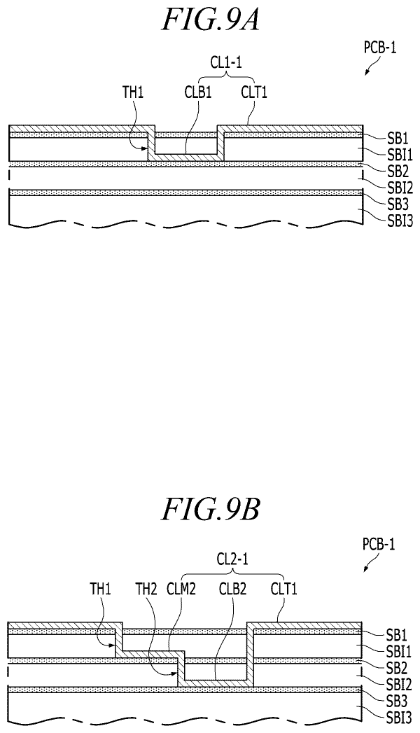

FIG. 7 is a schematic illustration showing an operation method of an input detection circuit ISC according to an embodiment of the present disclosure.

Referring to FIG. 7, a touch operation may include a process of an input detection driving unit IDR to provide a free charge voltage Vpre and a driving signal Vdrv to sensors SN, and a process of an input detection unit IDT to detect a touch. The process of detecting a touch may refer to a process for detection of a touch from outside and determination of a coordination of a touch. In an embodiment, the input detection driving circuits TIC1, TIC2, and TIC3 may each include an input detection driving unit IDR and an input detection unit IDT. The input detection driving unit IDR may be configured to provide a free charge voltage Vpre and a driving signal Vdrv to a sensor SN and receive a detection signal corresponding to a driving signal from the sensor SN to determine a coordination of a touch.

In an embodiment, for example, a free charging transistor TRP of the input detection driving unit IDR may be controlled by a gate voltage Vg to apply a free charge voltage Vpre to a sensor SN. The input detection circuit ISC according to an embodiment of the present disclosure may include a driving signal generation unit (not shown) in the input detection driving unit IDR for enhancement of a touch sensibility. Upon detection of a touch, the driving signal generation unit may apply a driving signal Vdrv to a driving capacitor Cdrv. In an embodiment of the present disclosure, the driving capacitor Cdrv may be a capacitor formed between a sensor SN to be sensed and other elements (e.g., another sensor or signal lines) adjacent to the sensor SN to be sensed. In an embodiment of the present disclosure, the driving signal Vdrv may be a pulse type signal having a variable voltage level.

When a finger FG touches a portion adjacent to a sensor SN, a contact capacitive capacitance Ct may be generated. For example, in a case that a finger FG touches a window member WP overlapping the sensor SN in a thickness direction or the third direction DR3, a contact capacitive capacitance Ct may be generated.

In an embodiment of the present disclosure, a capacitive capacitance value Cgnd or a voltage of a sensing node NS formed between the second driving electrode DE2 and the sensor SN may be changed based on a touch ground voltage Vgnd applied to the second driving electrode DE2 (see FIG. 6)

In a state that a driving signal Vdrv is applied to a driving capacitor Cdrv, the input detection unit IDT may be configured to determine whether a finger FG touches on a sensor SN or a coordination of a touch based on a voltage difference between when a contact capacitive capacitance Ct is generated and when the contact capacitive capacitance Ct is not generated.

For example, when a finger FG of a user makes contact with at least one of the sensors SN, a contact capacitive capacitance Ct may be generated between the finger FG and the sensors SN, and a capacitive capacitance value Cgnd or a voltage of a sensing node NS may be changed by the contact capacitive capacitance Ct. The changed capacitive capacitance value Cgnd or the changed voltage of a sensing node NS may be transferred to the input detection unit IDT through the signal lines SGL connected to the sensors SN with which the finger FG makes contact. The input detection unit IDT may determine the signal lines SGL, which receives the changed capacitive capacitance value Cgnd or the changed voltage of a sensing node NS, and a coordination of the touch. That is, the input detection unit IDT may be configured to detect the change in self-capacitance formed by the sensor SN and determine a coordination of a touch.

Each of FIGS. 8A and 8B is a schematic illustration of a portion of a cross-section of a circuit board according to an embodiment of the present disclosure.

The circuit board PCB according to an embodiment of the present disclosure may include a plurality of layers, and FIGS. 8A and 8B illustrate only a portion of the plurality of layers of the circuit board PCB.

Referring to FIGS. 8A and 8B, in an embodiment, the circuit board PCB may include a plurality of substrate layers SB1, SB2, and SB3, a plurality of substrate insulating layers SBI1, SBI2, and SBI3, and connection lines CL1, and CL2.

At least a portion of the connection lines CL1 and CL2 may be disposed on the first substrate layer SB1. The first substrate insulating layer SBI1 may be disposed below the first substrate layer SB1. The second substrate layer SB2 may be disposed below the first substrate insulating layer SBI1. The second substrate insulating layer SBI2 may be disposed below the second substrate layer SB2. The third substrate layer SB3 may be disposed below the second substrate insulating layer SBI2. The third substrate insulating layer SBI3 may be disposed below the third substrate layer SB3.

FIG. 8A is a schematic illustration of a cross-section corresponding to a portion of the circuit board PCB where the first connection line CL1 is disposed. Referring to FIG. 8A, the first connection line CL1 may be disposed on the first substrate layer SB1.

FIG. 8B is a schematic illustration of a cross-section corresponding to another portion of the circuit board PCB where the second connection line CL2 is disposed. Referring to FIG. 8B, the second connection line CL2 may include an upper connection line CLT and a lower connection line CLB. The upper connection line CLT may be a portion of the second connection line CL2 disposed on the first substrate layer SB1. The lower connection line CLB may be a portion of the second connection line CL2 disposed between the first substrate insulating layer SBI1 and the second substrate layer SB2. The upper connection line CLT and the lower connection line CLB may be electrically connected to each other through first penetrating holes TH1 defined in the first substrate layer SB1 and the first substrate insulating layer SBI1. As shown in FIG. 8B, the upper connection line CLT and the lower connection line CLB of the second connection line CL2 are disposed in (or directly on) different layers to have a length of the second connection line CL2 longer than a length of the first connection line CL1.

Each of FIGS. 9A and 9B is a schematic illustration of a portion of a cross-section of a circuit board PCB-1 according to an embodiment of the present disclosure.

FIG. 9A is a schematic illustration of a cross-section corresponding to a portion of the circuit board PCB-1 where the first connection line CL1-1 is disposed. Referring to FIG. 9A, the first connection line CL1-1 may include a first upper connection line CLT1 and a first lower connection line CLB1. The first upper connection line CLT1 may be a portion of the first connection line CL1-1 disposed on the first substrate layer SB1. The first lower connection line CLB1 may be a portion of the first connection line CL1-1 disposed between the first substrate insulating layer SBI1 and the second substrate layer SB2. The first upper connection line CLT1 and the first lower connection line CLB1 may be electrically connected to each other through the first penetrating holes TH1 defined in the first substrate layer SB1 and the first substrate insulating layer SBI1.

FIG. 9B is a schematic illustration of a cross-section corresponding to a portion of the circuit board PCB-1 where the second connection line CL2-1 is disposed. Referring to FIG. 9B, the second connection line CL2-1 may include a second upper connection line CLT2, a middle connection line CLM, and a second lower connection line CLB2. The second upper connection line CLT2 may be a portion of the second connection line CL2-1 disposed on the first substrate layer SB1. The middle connection line CLM may be another portion of the second connection line CL2-1 disposed between the first substrate insulating layer SBI1 and the second substrate layer SB2. The second lower connection line CLB2 may be yet another portion of the second connection line CL2-1 disposed between the second substrate insulating layer SBI2 and the third substrate layer SB3.

The second upper connection line CLT2, the middle connection line CLM, and the second lower connection line CLB2 may be electrically connected to one another through the first penetrating holes defined in the first substrate layer SB1 and the first substrate insulating layer SBI1 and second penetrating holes TH2 defined in the second substrate layer SB2 and the second substrate insulating layer SBI2. As shown in FIG. 9B, the second connection line CL2-1 may be disposed in three different layers, and a length of the second connection line CL2-1 may be longer than a length of the first connection line CL1-1 disposed over two different layers.

Each of FIGS. 10A and 10B is a schematic illustration of a portion of a cross-section of a circuit board PCB-2 according to an embodiment of the present disclosure.

FIG. 10A is a schematic illustration of a cross-section corresponding to a portion of the circuit board PCB-2 where the first connection line CL1-1 is disposed. A description for FIG. 10A is substantially the same as the description for FIG. 9A, and therefore any repetitive detailed description thereof will be omitted.

FIG. 10B is a schematic illustration of a cross-section corresponding to another portion of the circuit board PCB-2 where the second connection line CL2-2 is disposed. Referring to FIG. 10B, the second connection line CL2-2 may include a second upper connection line CL2-1, a middle connection line CLM-1, and a second lower connection line CL2-1. As the structure of the second upper connection line CL2-1, the middle connection line CLM-1, and the second lower connection line CL2-1 shown in FIG. 10B is merely partially different from the structure of the second upper connection line CLT2, the middle connection line CLM, and the second lower connection line CLB2 shown in FIG. 9B, the substantial descriptions are substantially the same as each other, and therefore any repetitive detailed description thereof will be omitted.

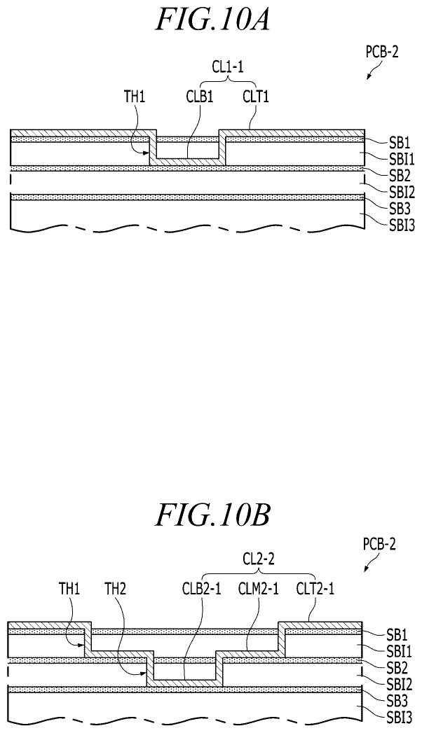

FIG. 11 is a schematic illustration of a planarly viewed shape of a portion of a circuit board PCB according to an embodiment of the present disclosure. Specifically, FIG. 11 is a plan view showing a shape of the lower connection line CLB in FIG. 8B viewed on a plane or when viewed in the third direction DR3. Referring to FIG. 11, the lower connection line CLB may be disposed to have a winding or zigzag shape on a plane to increase an overall length of the second connection line CL2. However, the present disclosure is not limited thereto, and the lower connection line CLB2 may be disposed to have a straight shape on a plane.

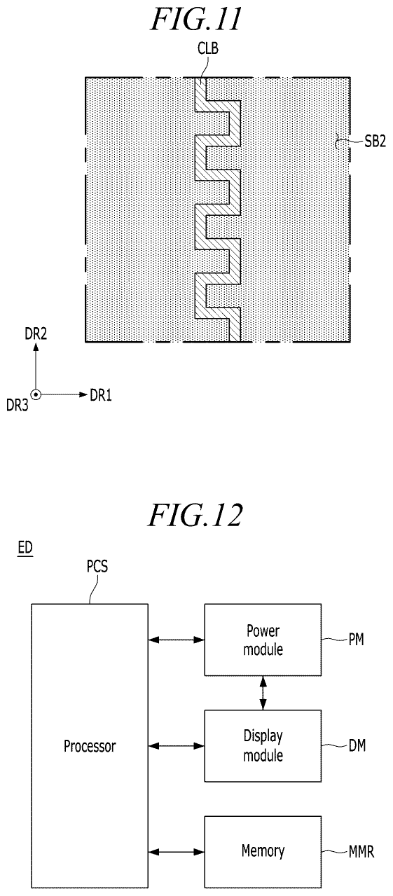

FIG. 12 is a block diagram of an electronic device ED according to an embodiment.

Referring to FIG. 12, the electronic device ED according to an embodiment may include a display module DM, a processor PCS, a memory MMR, and a power module PM.

The processor PCS may include at least one selected from a central processing unit (CPU), an application processor (AP), a graphic processing unit (GPU), a communication processor (CP), an image signal processor (ISP), and a controller.

The memory MMR may be configured to store data information for operation of the processor PCS or the display module DM. In a case where the processor PCS operates an application stored in the memory MMR, the display module may be configured to receive an image data signal and/or an input control signal and process the received signal to provide an output of image information through a display screen.

The power module PM may include a power supply module, such as a power adapter or a batter device, and a power conversion module, which converts power supplied by the power supply module to generate power required for operation of an electronic device ED.

At least one of the elements of the described electronic device ED may be included in a display device according to the embodiments described above. In addition, some of individual modules functionally included in a single module may be included in the display device, and the other may be provided separately from the display device. In an embodiment, for example, a display module DM may be included in the display device, and the processor PCS, the memory MMR, and the power module PM may be provided in a form of another device within the electronic device ED other than the display device.

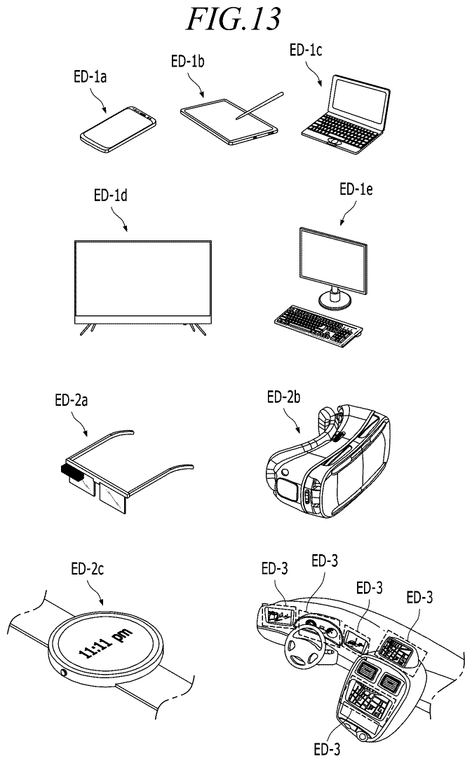

FIG. 13 are schematic diagrams of an electronic device ED according to various embodiments.

Referring to FIG. 13, various electronic devices including display devices according to embodiments may include not only an image display electronic device, such as a smart phone ED-1a, a tablet computer ED-1b, a laptop ED-1c, a television (TV) ED1-d, and a desk monitor ED-1e, but also a wearable electronic device including a display module, such as smart glasses ED-2a, a head mounted display ED-2b, and a smart watch ED-2c, and a vehicle electronic device ED-3 including a display module, such as a dashboard of an automobile, center fascia, and center information display (CID) and a room mirror display disposed on an instrument panel.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display module comprising:
a display panel comprising a display region and a non-display region surrounding the display region;
a plurality of sensors provided on the display region and comprising a first sensor and a second sensor disposed adjacent to the first sensor;
a first multiplexor electrically connected to the first sensor;
a second multiplexor electrically connected to the second sensor and spaced apart from the first multiplexor;
a first spider line electrically connected to the first multiplexor, provided on the non-display region, and having a first length;
a second spider line electrically connected to the second multiplexor, provided on the non-display region, and having a second length shorter than the first length;
a plurality of flexible printed circuit boards at least any one of the plurality of flexible printed circuit boards being electrically connected to at least any one of the first spider line and the second spider line;
a circuit board comprising a first connection line having a third length and a second connection line having a fourth length longer than the third length, the first connection line and the second connection line being electrically connected to the first spider line and the second spider line, respectively, through at least any one of the plurality of flexible printed circuit boards a first input detection driving circuit electrically connected to the first connection line and mounted on the circuit board; and
a second input detection driving circuit electrically connected to the second connection line and mounted on the circuit board.

2. The display module of claim 1, wherein:
the circuit board further comprises a first substrate layer, a second substrate layer, and a first substrate insulating layer disposed between the first substrate layer and the second substrate layer;
the first connection line is provided on the first substrate layer; and
a portion of the second connection line is disposed on the first substrate layer and another portion of the second connection line is disposed between the first substrate insulating layer and the second substrate layer.

3. The display module of claim 1, wherein:
the circuit board further comprises a first substrate layer, a second substrate layer, and a first substrate insulating layer disposed between the first substrate layer and the second substrate layer;
the first connection line comprises a first upper connection line disposed on the first substrate layer, and a first lower connection line disposed between the first substrate insulating layer and the second substrate layer; and
the second connection line comprises a second upper connection line disposed on the first substrate layer, and a second lower connection line disposed between the first substrate insulating layer and the second substrate layer.

4. The display module of claim 1, wherein:
the circuit board further comprises a first substrate layer, a second substrate layer, a third substrate layer, a first substrate insulating layer disposed between the first substrate layer and the second substrate layer, and a second substrate insulating layer disposed between the second substrate layer and the third substrate layer;
the first connection line comprises a first upper connection line disposed on the first substrate layer, and a first lower connection line disposed between the first substrate insulating layer and the second substrate layer, and
the second connection line comprises a second upper connection line disposed on the first substrate layer, a middle connection line disposed between the first substrate insulating layer and the second substrate layer, and a second lower connection line disposed between the second substrate insulating layer and the third substrate layer.

5. The display module of claim 1, wherein a capacitance formed by the first connection line with other elements is 0.9 times or greater and 1.1 times or less of a capacitance formed by the second connection line with other elements.

6. The display module of claim 1, wherein
no sensor among the plurality of sensors is disposed between the first sensor and the second sensor,
the second sensor is spaced apart from the first sensor in a first direction, and
the second multiplexor is spaced apart from the first multiplexor in the first direction.

7. The display module of claim 6, wherein
the first input detection driving circuit detects a change in a capacitance formed by the first sensor with other elements, and
the second input detection driving circuit detects a change in a capacitance formed by the second sensor with other elements.

8. The display module of claim 7, wherein the plurality of flexible printed circuit boards is bendable to have the circuit board overlap the display panel.

9. An electronic device comprising:
a plurality of sensors comprising a first sensor and a second sensor disposed adjacent to the first sensor, wherein each of the first sensor and the second sensor forms a capacitance with objects approaching from outside;
a first multiplexor electrically connected to the first sensor;
a second multiplexor electrically connected to the second sensor and spaced apart from the first multiplexor;
a first spider line electrically connected to the first multiplexor and having a first length;
a second spider line electrically connected to the second multiplexor and having a second length shorter than the first length;
a circuit board comprising a first connection line having a third length and a second connection line having a fourth length longer than the third length, wherein the first connection line is electrically connected to the first spider line and the second connection line is electrically connected to the second spider line;
a first input detection driving circuit electrically connected to the first connection line, wherein the first input detection driving circuit detects a change in the capacitance of the first sensor; and
a second input detection driving circuit electrically connected to the second connection line, wherein the second input detection driving circuit detects a change in the capacitance of the second sensor.

10. The electronic device of claim 9, wherein:
the circuit board further comprises:
a first substrate layer;
a first substrate insulating layer disposed below the first substrate layer; and
a second substrate layer disposed below the first substrate insulating layer, and
a portion of the second connection line is disposed on the first substrate layer, and another portion of the second connection line is disposed between the first substrate insulating layer and the second substrate layer.

11. The electronic device of claim 10, wherein no sensor among the plurality sensors is disposed between the first sensor and the second sensor.

12. The electronic device of claim 11, wherein the first sensor is electrically insulated from the second sensor.

13. The electronic device of claim 12, wherein each of the plurality of sensors allows penetration or passing of at least some of incident light.

14. The electronic device of claim 13, further comprising a display panel disposed to overlay the plurality of sensors.

15. The electronic device of claim 13, further comprising a plurality of flexible printed circuit boards, at least one of the plurality of flexible printed circuit boards electrically connected to at least any one of the first spider line and the second spider line.

16. The electronic device of claim 15, wherein a capacitance formed by the first connection line with other elements is 0.9 times or greater and 1.1 times or less of a capacitance line with other elements is 0.9 times or greater and 1.1 times or less of a capacitance formed by the second connection line with other elements.

17. An electronic part comprising:
a first substrate layer;
a first substrate insulating layer disposed below the first substrate layer;
a second substrate layer disposed below the first substrate insulating layer; and
a plurality of connection lines, wherein each of the plurality of connection lines includes a portion disposed on the first substrate layer,
wherein among the plurality of connection lines, a length of a first connection line electrically connected to a first external part is different from a length of a second connection line electrically connected to a second external part.

18. The electronic part of claim 17, wherein a portion of the second connection line is disposed on the first substrate layer, and another portion of the second connection line is disposed between the first substrate insulating layer and the second substrate layer.

19. The electronic part of claim 18, wherein:
the first external part is a first multiplexor, and
the second external part is a second multiplexor spaced apart from the first multiplexor.

20. The electronic part of claim 19, further comprising:
a first input detection driving circuit electrically connected to the first multiplexor; and
a second input detection driving circuit electrically connected to the second multiplexor.
